(19) United States
(12) Patent Application Publication
(10) Pub. No.: US 2006/0034007 A1
(43) Pub. Date: Feb. 16, 2006

(54) Disk recording apparatus

(76) Inventors: Sang Jin Choi, Yongin-si (KR); Young Kun Kwon, Suwon-si (KR); Tae Hwan Kim, Suwon-si (KR); Hyun Jin Lee, Suwon-Si (KR); Kyung Bin Lee, Seoul (KR)

Correspondence Address: STANZIONE & KIM, LLP, 919 18TH STREET, N.W., SUITE 440, WASHINGTON, DC, 20006, US

(21) Appl. No.: 11/131,237

(22) Filed: May 18, 2005

(30) Foreign Application Priority Data
Aug. 10, 2004 (KR) 2004-62743

(51) Int. Cl. G11B 5/09; G11B 21/02

(52) U.S. Cl. 360/51; 360/75

(57) ABSTRACT

A disk recording apparatus includes a disk to store data, a motor to rotate the disk, an encoder to generate a pulse according to the rotation of the disk, a reference signal output part to output a reference clock signal created using the pulse of the encoder, and a servo writer to record servo data on the disk in synchronization with the reference clock signal supplied from the reference signal output part. The disk recording apparatus can supply an index signal and the reference clock signal in the form of a pulse output from the encoder to detect a motor velocity.

### CROSS-REFERENCE TO RELATED APPLICATIONS

This application claims the benefit under 35 U.S.C. § 119 of Korean Patent Application No. 2004-62743, filed on Aug. 10, 2004 in the Korean Intellectual Property Office, the disclosure of which is incorporated herein in its entirety and by reference.

### BACKGROUND OF THE INVENTION

1. Field of the Invention

The present general inventive concept relates to a disk recording apparatus, and more particularly, to a disk recording apparatus to record servo data on a disk using a pulse of an encoder.

2. Description of the Related Art

A hard disk drive comprises components, such as a disk capable of storing data, a head capable of recording or reading the data on or from the disk, and the like.

In order to successfully read or record the data on or from the disk, the head is moved to a target track, and subsequently, predetermined servo data must be recorded on the disk in order to trace the target track, which is performed by a servo writer.

A conventional servo writer performs a servo writing process to record the servo data on the disk after receiving a reference clock signal and an index signal from a clock head module. The clock head module comprises a clock head capable of reading/recording the data, and sends the index signal indicating the reference clock signal of a predetermined frequency and a rotational cycle of the disk to the servo writer after performing a signal process for a signal read by the clock head when recording and servo writing the reference clock on the disk by the clock head.

However, the large number of the components for the clock head module for performing the signal process increases an economic burden. While the clock head is loaded and positioned near the disk to record or read the reference clock, the clock head tends to contact the disk, damaging the clock head. Additionally, not only does a short life span of the clock head necessitate a frequent replacement of the clock head, but also contamination of the clock head by foreign matter causes distortion of the clock signal recorded on the disk by the clock head, thereby producing a deformed disk.

### SUMMARY OF THE INVENTION

The present general inventive concept provides a disk recording apparatus designed to record servo data on a disk using a pulse of an encoder, which is generated according to a rotation of the disk.

Additional aspects and/or advantages of the general inventive concept will be set forth in part in the description which follows and, in part, will be obvious from the description, or may be learned by practice of the general inventive concept.

The foregoing and/or other aspects and advantages of the present general inventive concept may be achieved by providing a disk recording apparatus comprising at least one disk to store data, a motor to rotate the disk, an encoder to generate a pulse according to the rotation of the disk, a reference signal output part to output a reference clock signal created using the pulse of the encoder, and a servo writer to record servo data on the disk in synchronization with the reference clock signal supplied from the reference signal output part.

The reference signal output part may comprise a frequency converting part to convert a frequency of the pulse output from the encoder into a signal representing a frequency of the reference clock signal, and a restoring part to restore the signal of the frequency converting part to the reference clock signal.

The frequency converting part may comprise a multiplication part to multiply the pulse of the encoder by a predetermined number, and a clock frequency generating part to generate the signal according to the multiplied pulse of the multiplication part.

The restoring part may comprise a comparing part to compare the output of the frequency converting part with a reference value to output a clock signal, and a voltage level converting part to convert a voltage level of the clock signal output from the comparing part into a predetermined voltage level so that the reference clock signal having the predetermined voltage level is generated.

The reference signal output part may further comprise an index signal generating part to generate an index signal showing a rotational cycle of the disk after receiving the pulse of the encoder.

The servo writer may perform a servo writing process using the index signal and the reference clock signal supplied from the index signal generating part.

The encoder may generate a predetermined number of pulses each rotation of the disk as the pulse.

The encoder may generate the pulse corresponding to a rotational velocity of the disk.

The foregoing and/or other aspects and advantages of the present general inventive concept may also be achieved by providing a disk recording apparatus comprising at least one disk applied to a hard disk drive, a motor to rotate the disk, a pulse generating part to generate a pulse corresponding to a velocity of the motor, a reference signal output part to output a reference clock signal having a frequency established according to the pulse of the pulse generating part and an index signal corresponding to a rotational cycle of the disk, and a servo writer to record servo data on the disk using the reference clock signal and the index signal of the reference signal output part.

The pulse generation part may output a predetermined number of pulses corresponding to each rotation of the disk as the pulse.

### BRIEF DESCRIPTION OF THE DRAWINGS

These and/or other aspects and advantages of the general inventive concept will become apparent and more readily appreciated from the following description of the embodiments, taken in conjunction with the accompanying drawings, of which:

FIG. 1 is a block diagram of a disk recording apparatus according to an embodiment the present general inventive concept;

FIG. 2 is a schematic perspective view of the disk recording apparatus of FIG. 1; and

FIG. 3 shows outputs of respective parts of the disk recording apparatus of FIG. 1.

### DETAILED DESCRIPTION OF THE PREFERRED EMBODIMENTS

Reference will now be made in detail to the embodiment of the present general inventive concept, examples of which are illustrated in the accompanying drawings, wherein like reference numerals refer to like element through. The embodiment is described below to explain the present general inventive concept by referring to the drawings.

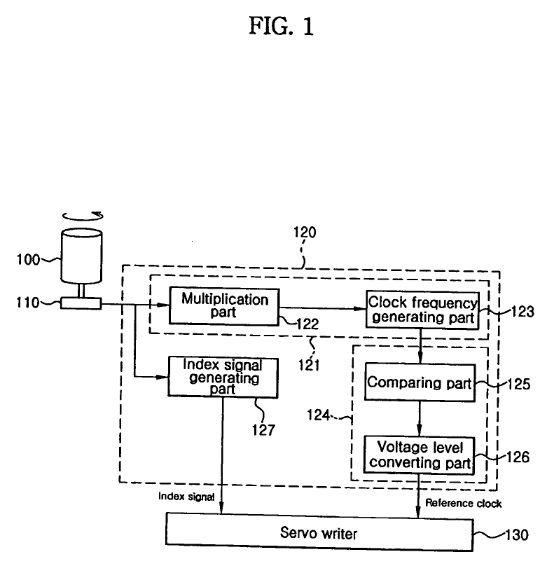

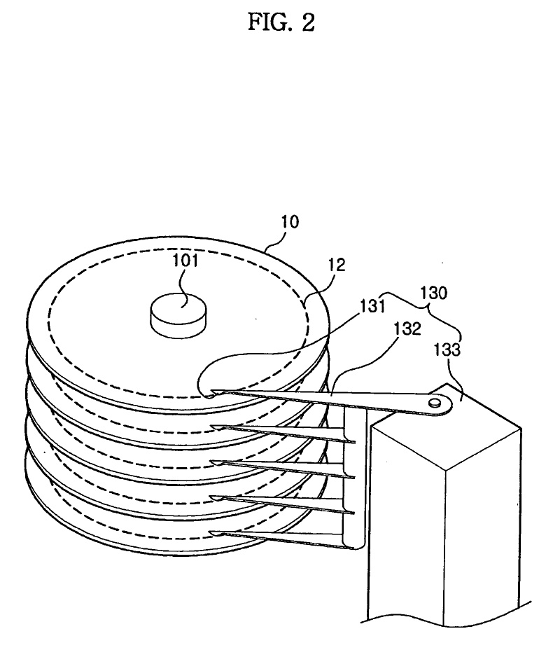

Referring to FIGS. 1 and 2, a disk recording apparatus according to an embodiment of the present general inventive concept comprises a servo writer 130 to record servo data on a plurality of disks 10.

The plurality of disks 10 is equipped with a rotational shaft 101 of a motor, and the disks 10 are spaced apart by a predetermined distance from each other on the rotational shaft 101. The rotational shaft 101 is driven by a spindle motor 100 (referred to as a motor hereinafter) to rotate the disks 10.

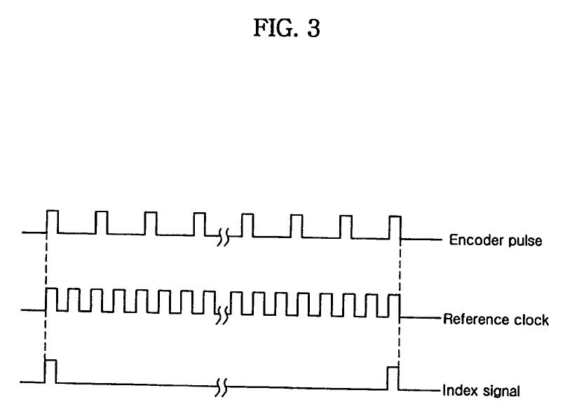

There is provided an encoder 110 at one side of the disks 10 to generate predetermined pulses corresponding to the rotation of each of the disks 10. The encoder 110 outputs a predetermined number of pulses according to the rotation of the motor 100, that is, each rotation of the disk 10. Here, as shown in FIG. 3, the encoder 110 outputs the pulses corresponding to the rotation of the disk. The pulses of the encoder 110 are applied to a reference signal output part 120, which will be described below, and to a motor controller, not shown, to control driving of the motor 100. The motor controller controls a velocity of the motor 100 with reference to the pulse of the encoder 110.

The reference signal output part 120 outputs an index signal and a reference clock signal, as shown in FIG. 3, and connects the encoder 110 and the servo writer 130.

The reference signal output part 120 comprises a frequency converting part 121 to convert a frequency of each of the pulses output from the encoder 110 into a signal, and a restoring part 124 to restore the signal of the frequency converting part 121, to the reference clock signal.

The reference signal output part 120 can further comprise an index signal generating part 127 to generate the index signal indicating a rotational cycle of the disk 10 after receiving the pulses of the encoder 110. As shown in FIG. 3, the index signal generating part 127 outputs the index signal corresponding to each rotation of the plurality of disks 10. The index signal generating part 127 outputs the index signal at every time when each of the pulses of the encoder 110 has a predetermined value corresponding to one rotation of the disks 10 by counting the pulses of the encoder 110.

The frequency converting part 121 can comprise a multiplication part 122 to multiply each of the pulses of the encoder 110 by a predetermined number, and a clock frequency generating part 123 to generate the signal representing a frequency of the reference clock signal by changing the frequency of the pulses multiplied by the multiplication part 122 to the frequency of the reference clock signal supplied to the servo writer 130.

The restoring part 124 can comprise a comparing part 125 to output a clock signal after comparing the output of the frequency converting part 121 with a reference value, and a voltage level converting part 126 to convert a voltage level of the clock signal output from the comparing part 125 and to output the reference clock signal.

The servo writer 130 can comprise a plurality of servo writer heads 131, a plurality of servo writer arms 132 supporting the servo writer heads 131, and a positioner 133 rotatably coupled to the servo writer arms 132 to adjust a position of the servo writer heads 131 with respect to the disks 10.

The servo writer 130 performs a servo writing process, in which servo data is recorded from a start track 12 of each of the disks 10, using the index signal and the reference clock signal supplied from the index signal generating part 120.

Each of the servo writer heads 131 corresponds to each of the disks 10, so that each of the servo writer heads 131 can record the servo data on the corresponding disk 10. The servo writer arms 132 support the plurality of servo writer heads 131, respectively, and are rotatably connected to the positioner 132. The positioner 133 is rotatably coupled to the servo writer arms 132, and rotates at a predetermined angle in order to adjust the position of the servo writer heads 131.

Operations of the disk recording apparatus of FIGS. 1 and 2 will be described as follows.

First, the plurality of disks 10 is installed at the rotational shaft 101. The motor 100 is driven by the motor controller (not shown). The rotational shaft 101 rotates the plurality of disks 10 through the driving of the motor 100. At this time, the encoder 110 outputs the pulses according to the rotation of the disks 10. The motor controller controls the driving of the motor 100 after computing the velocity of the motor 100 with reference to the pulses of the encoder 110.

The pulses of the encoder 110 are input to the reference signal output part 120. The multiplication part 122 of the reference signal output part 120 outputs a multiplied clock signal by multiplying each of the pulses of the encoder 110 by the predetermined number, for example, by four, so that the frequency of the pulses of the encoder 110 is changed (increased) to a predetermined frequency according to the predetermined number, and the clock frequency generating part 123 generates the signal representing the frequency of the reference clock signal by changing a frequency of the multiplied clock signal to the predetermined frequency of the reference clock signal. The predetermined frequency is given as the frequency of the reference clock signal, which will be supplied to the servo writer 130. The comparing part 125 of the restoring part 124 outputs the clock signal after comparing the signal generated by the clock frequency generating part 123 with the reference value, so that the signal changed by the clock frequency generating part 123 is generated as the clock signal. At this time, the voltage level converting part 126 converts a voltage level of the clock signal output from the comparing part 125 to a predetermined voltage level, for example, to 5 V, and outputs the reference clock signal having the converted voltage to the servo writer 130.

An index signal generating part 127 generates the index signal to the servo writer 130 corresponding to each rotation of the disks 10.

The servo writer 130 performs a servo writing process, in which the servo data is recorded from the start track 12 of each of the disks 10, using the index signal and the reference clock supplied from the index signal generating part 120.

As is apparent from the above description, according to the present general inventive concept, a disk recording apparatus is configured to supply an index signal and a reference clock signal, which are generated after receiving an encoder pulse used to detect a velocity of a motor, to a servo writer, thereby lowering manufacturing costs, allowing easy maintenance, and enhancing productivity by restricting generation of deformed disks.

Although an embodiment of the present general inventive concept has been shown and described, it would be appreciated by those skilled in the art that changes may be made in this embodiment without departing from the principles and spirit of the general inventive concept, the scope of which is defined in the claims and their equivalents.

What is claimed is:

1. A disk recording apparatus, comprising:
at least one disk to store data;
a motor to rotate the disk;
an encoder to generate a pulse according to the rotation of the disk;
a reference signal output part to output a reference clock signal created using the pulse of the encoder; and
a servo writer to record servo data on the disk in synchronization with the reference clock signal supplied from the reference signal output part.

2. The disk recording apparatus according to claim 1, wherein the reference signal output part comprises:
a frequency converting part to convert a frequency of the pulse output from the encoder into a signal representing a frequency of the reference clock signal; and
a restoring part to restore the signal of the frequency converting part to the reference clock signal.

3. The disk recording apparatus according to claim 2, wherein the frequency converting part comprises:
a multiplication part to multiply the pulse of the encoder by a predetermined number; and
a clock frequency generating part to generate the signal according to the multiplied pulse of the multiplication part.

4. The disk recording apparatus according to claim 2, wherein the restoring part comprises:
a comparing part to compare the signal of the frequency converting part with a reference value to output a clock signal; and
a voltage level converting part to convert a voltage level of the clock signal output from the comparing part into a predetermined voltage level so that the reference clock signal having the predetermined voltage level is generated.

5. The disk recording apparatus according to claim 2, wherein the reference signal output part further comprises:
an index signal generating part to generate an index signal indicating a rotational cycle of the disk after receiving the pulse of the encoder.

6. The disk recording apparatus according to claim 5, wherein the servo writer performs a servo writing process from a start track of the disk, using the index signal and the reference clock supplied from the index signal generating part.

7. The disk recording apparatus according to claim 1, wherein the encoder generates a predetermined number of pulses corresponding to a rotational velocity of the disk as the pulse.

8. The disk recording apparatus according to claim 1, wherein the encoder generates the pulse corresponding to a rotational velocity of the disk.

9. The disk recording apparatus according to claim 1, wherein the reference signal output part generates an index signal indicating a rotational cycle of the disk according to the pulse of the encoder, and the servo writer records the servo data on the disk according to the reference clock signal and the index signal.

10. The disk recording apparatus according to claim 1, wherein the reference signal output part multiplies the pulse of the encoder by a predetermined number to generate a signal representing a frequency of the reference clock signal, and generates the reference clock signal according to the signal.

11. The disk recording apparatus according to claim 1, wherein the reference signal output part multiplies a frequency of the pulse of the encoder by a predetermined number to generate a signal representing a frequency of the reference clock signal, and generates the reference clock signal according to the signal

12. The disk recording apparatus according to claim 11, wherein the frequency of the pulse and the frequency of the reference clock signal are different from each other.

13. The disk recording apparatus according to claim 11, wherein the predetermined number is an integer.

14. The disk recording apparatus according to claim 1, wherein the reference signal output part outputs the reference clock signal which is variable according to the pulse of the encoder.

15. The disk recording apparatus according to claim 1, wherein the pulse of the encoder represents a rotational velocity of the disk.

16. The disk recording apparatus according to claim 1, wherein the reference signal output part converts a first frequency of the pulse of the encoder into a signal representing a second frequency, and generates the reference clock signal according to the signal.

17. The disk recording apparatus according to claim 1, wherein the reference signal output part changes a first frequency of the pulse of the encoder to a second frequency, and generates the reference clock signal corresponding to the second frequency.

18. A disk recording apparatus, comprising:
a disk applied to a hard disk drive;
a motor to rotate the disk;
a pulse generating part to generate a pulse corresponding to a velocity of the motor;
a reference signal output part to output a reference clock signal of a frequency set according to the pulse of the pulse generating part and an index signal corresponding to a rotational cycle of the disk; and
a servo writer to record servo data on the disk using the reference clock signal and the index signal of the reference signal output part.

19. The disk recording apparatus according to claim 18, wherein the pulse generating part comprises an encoder to generate a predetermined number of pulses corresponding to a rotational velocity of the disk as the pulse.

20. A method of recording servo data on a disk, the method comprising:
rotating a disk;
generating a pulse according to the rotation of the disk;
generating a reference clock signal according to the generated pulse signal;
recording servo data on the disk in synchronization with the reference clock signal.

21. The method according to claim 20, further comprising:
generating an index signal indicating a rotational cycle of the disk according to the generated pulse signal,
wherein the recording of the servo data comprises recording the servo data according to the reference clock signal and the index signal.
